(19) United States
(12) Patent Application Publication
(10) Pub. No.: US 2017/0099468 A1
(43) Pub. Date: Apr. 6, 2017

(54) MEDICAL APPARATUS

(71) Applicant: Seiko Epson Corporation, Tokyo (JP)

(72) Inventors: Hideki TANAKA, Chino (JP); Yuya MARUYAMA, Chino (JP); Takayuki KITAZAWA, Suwa (JP); Yutaka Oouchida, Sendai (JP); Shinichi IZUMI, Sendai (JP)

(21) Appl. No.: 15/284,850

(22) Filed: Oct. 4, 2016

(30) Foreign Application Priority Data
Oct. 5, 2015 (JP) 2015-197264

(51) Int. Cl. H04N 9/31; G09B 5/02; G09B 19/00

(52) U.S. Cl. CPC H04N 9/3141; H04N 9/3179; G09B 19/00; G09B 5/02

(57) ABSTRACT

In a case where a patient is caused to perform a first emulating action, a moving image in which a therapy target part repeatedly moves is displayed on a screen member, and the therapy target part is shielded from the visual field of the patient by using the screen member. In a case where the patient is caused to perform a second emulating action, a transition operation for stopping the shielding is performed.

### BACKGROUND

1. Technical Field

The present invention relates to a medical apparatus.

2. Related Art

There is therapy in which a patient is made to visually recognize moving images in which a lost part moves and also to imagine that the lost part performs an emulating action in accordance with the moving images, in order to alleviate pain (phantom limb pain) of a lost limb. JP-A-2004-298430 discloses an apparatus using a half mirror as a medical apparatus used for the therapy.

In JP-A-2004-298430, only one aspect is taken into consideration for an emulating action, and thus therapy using a plurality of emulating actions cannot be performed.

### SUMMARY

An advantage of some aspects of the invention is to enable therapy using a plurality of emulating actions to be performed on the basis of the related art.

The invention can be implemented as the following aspects.

According to one aspect of the invention, a medical apparatus is provided. The medical apparatus includes a screen member on which a moving image in which a therapy target part repeatedly moves is displayed; and a control unit that shields the therapy target part from the visual field of a patient by using the screen member in a case where the patient is caused to perform a first emulating action, and that performs a transition operation for stopping the shielding in a case where the patient is caused to perform a second emulating action. According to the aspect, it is possible to cause the patient to perform the first and second emulating actions.

In the aspect, the screen member may allow an opposite side to be viewed therethrough in a case where an image including the moving image is not displayed, and the control unit may realize the shielding by displaying the image on the screen member, and may stop displaying of the image as the transition operation. According to the aspect, it is possible to realize the transition operation through a simple operation such as stoppage of displaying of the image.

In the aspect, the medical apparatus may further include a projection device that performs projection onto the screen member, the screen member may be formed of a beam splitter, and the control unit may display the moving image by causing the projection device to project the moving image onto the screen member. According to the aspect, it is possible to display the moving image through projection.

In the aspect, the medical apparatus may further include a power generation device that moves the screen member, and the control unit may cause the power generation device to move the screen member as the transition operation. According to the aspect, it is possible to realize the transition operation through a simple operation such as movement of the screen member.

The invention may be implemented in various aspects other than the aspect. For example, the invention may be implemented as a therapy method described below. A therapy method includes causing a patient to visually recognize a moving image in which a therapy target part repeatedly moves so as to shield the therapy target part from the visual field of the patient in a case where the patient is caused to perform a first emulating action; and stopping shielding in a case where the patient is caused to perform a second emulating action. In a case of the method, for example, an assistant may move the screen member for displaying the moving image so as to stop the shielding.

In addition, the invention may be implemented in aspects such as a computer program for performing the therapy method, and a non-transitory storage medium storing the computer program.

### BRIEF DESCRIPTION OF THE DRAWINGS

The invention will be described with reference to the accompanying drawings, wherein like numbers reference like elements.

FIG. 1 is a side view of a medical apparatus.

FIG. 2 is an exploded perspective view of a screen member and a box.

FIG. 3 is a diagram illustrating a state in which a patient puts their right hand and their left hand into the box.

FIG. 4 is a block diagram illustrating an internal configuration of a projector.

FIG. 5 is a flowchart illustrating a projection process.

FIG. 6 is a diagram illustrating an initial image.

FIG. 7 is an enlarged view of a dialogue screen.

FIG. 8 is a diagram illustrating a first state during reproduction of moving images.

FIG. 9 is a diagram illustrating a second state during reproduction of moving images.

FIG. 10 is a sectional view illustrating the first state during reproduction of moving images.

FIG. 11 is a sectional view illustrating the second state during reproduction of moving images.

FIG. 12 is a diagram illustrating a state in which projection is stopped, and both hands of a patient are in the second state.

FIG. 13 is a side view of a medical apparatus (hereinafter, Embodiment 2).

FIG. 14 is an exploded perspective view of a screen member and a box.

FIG. 15 is a diagram illustrating a state in which the screen member is pushed out or drawn.

FIG. 16 is a diagram illustrating a state in which a patient puts both hands into the box.

FIG. 17 is a block diagram illustrating an internal configuration of a projector.

FIG. 18 is a flowchart illustrating a projection process.

FIG. 19 is a diagram illustrating a state in which an initial image is projected.

FIG. 20 is a diagram illustrating a second state during reproduction of moving images.

FIG. 21 is a diagram illustrating an exposure state and a first state.

FIG. 22 is a diagram illustrating an exposure state and the second state.

### DESCRIPTION OF EXEMPLARY EMBODIMENTS

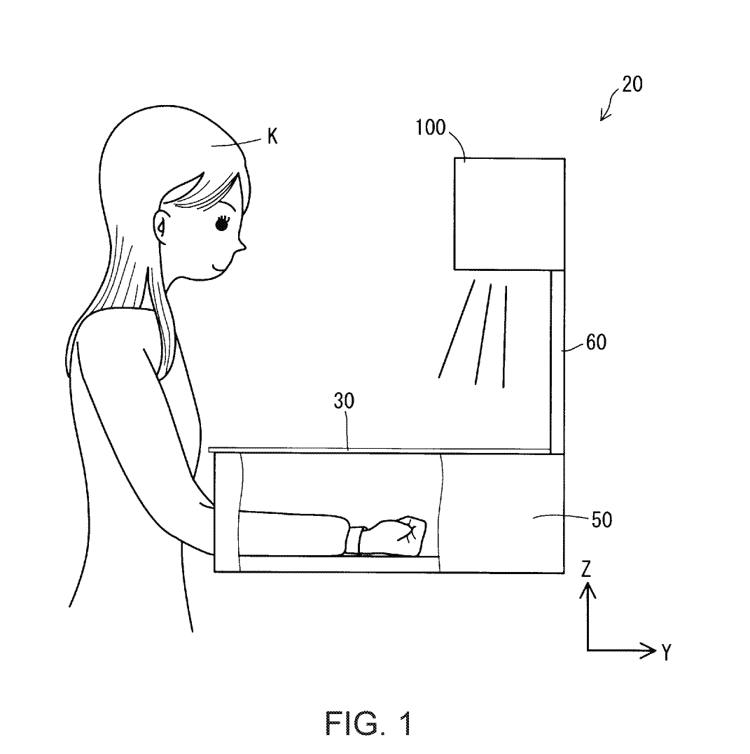

Embodiment 1 will be described. FIG. 1 is a side view of a medical apparatus 20. The medical apparatus 20 is used for therapy of phantom limb pain or rehabilitation of functions of the fingers. The medical apparatus 20 includes a screen member 30, a box 50, a column 60, and a projector 100. FIG. 1 illustrates a part of the box 50 which is virtually notched. In the present embodiment and Embodiment 2 which will be described later, a vertical direction is set as a Z direction, and a horizontal plane is set as an XY plane.

The projector 100 is a display device which projects a therapeutic moving image onto the screen member 30 as will be described later in detail. The column 60 is fixed to the box 50 and supports the projector 100.

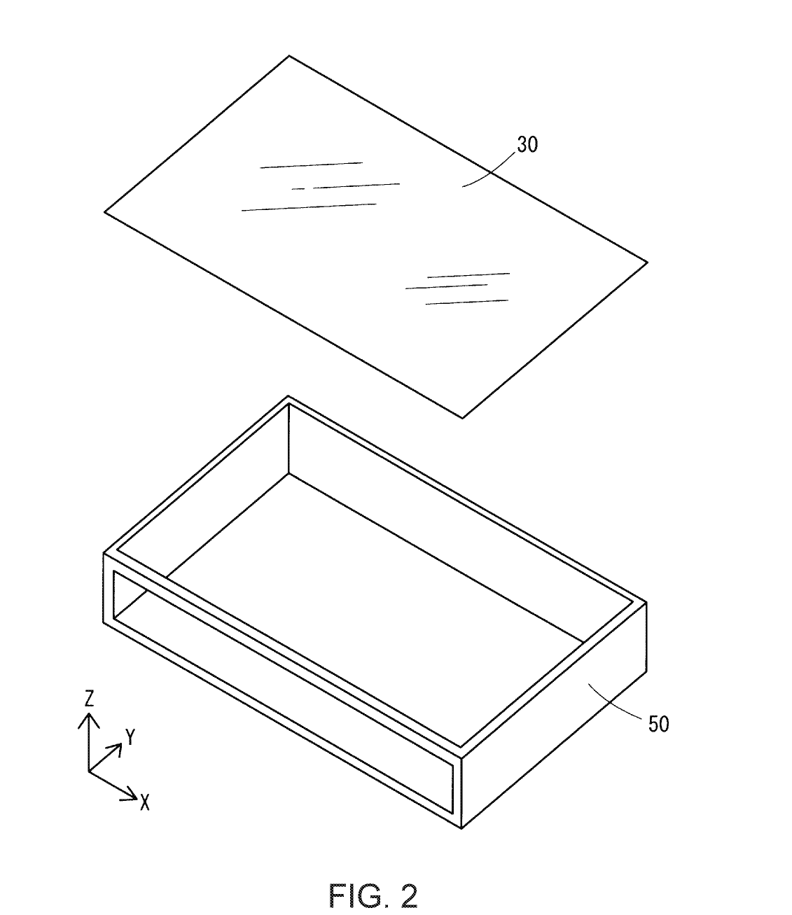

FIG. 2 is an exploded perspective view illustrating the screen member 30 and the box 50. During use of the medical apparatus 20, as illustrated in FIG. 1, the screen member 30 is placed on the box 50.

The screen member 30 is made of a material which functions as a beam splitter. Specifically, the screen member 30 has a structure in which metal thin films are formed on a front surface and a rear surface of a glass. In the present embodiment, a technical significance obtained as a result of the screen member 30 functioning as a beam splitter will be described later.

The box 50 has a substantially rectangular parallelepiped shape. One of four side faces of the box 50 is bored to leave a frame so that a patient K can place the hands and the forearms thereof on a bottom of the box. In the present embodiment, the hand indicates the front part from the wrist. The box 50 does not have a top face so that the patient K can visually recognize the hands put into the box.

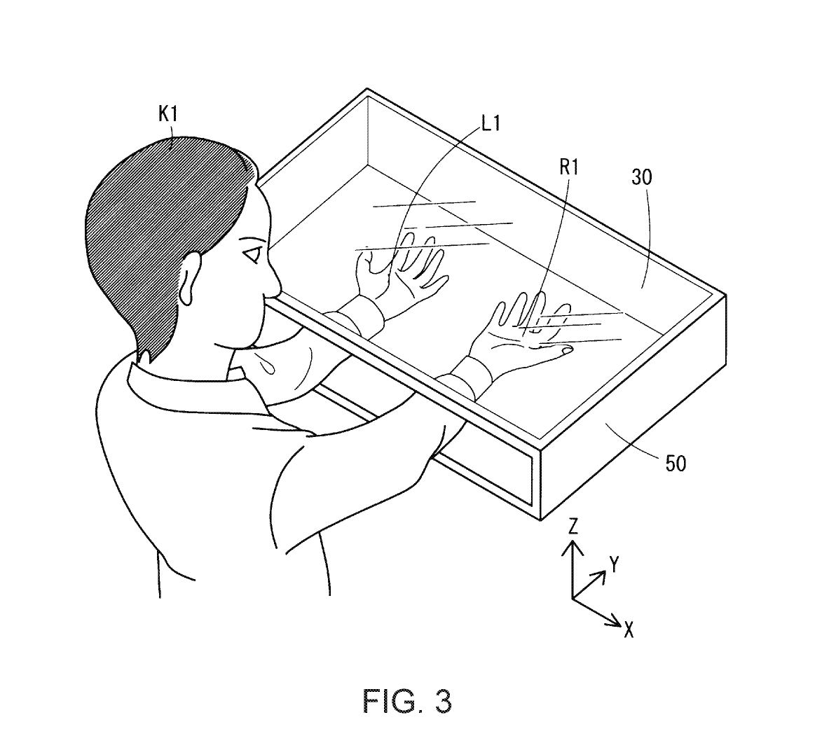

FIG. 3 illustrates a state in which a patient K1 puts the right hand R1 and the left hand L1 into the box 50 on which the screen member 30 is placed. The patient K1 has paralytic symptoms on both hands (the right hand R1 and the left hand L1) which are therapy target parts.

If the patient K1 puts both hands into the box, the screen member 30 is disposed between the therapy target parts and the eyes of the patient K1. The patient K1 can visually recognize both of the hands put into the box 50 through the screen member 30. The screen member 30 allows an opposite side to be transmitted therethrough and thus to be viewed except for a condition in which strong light is reflected.

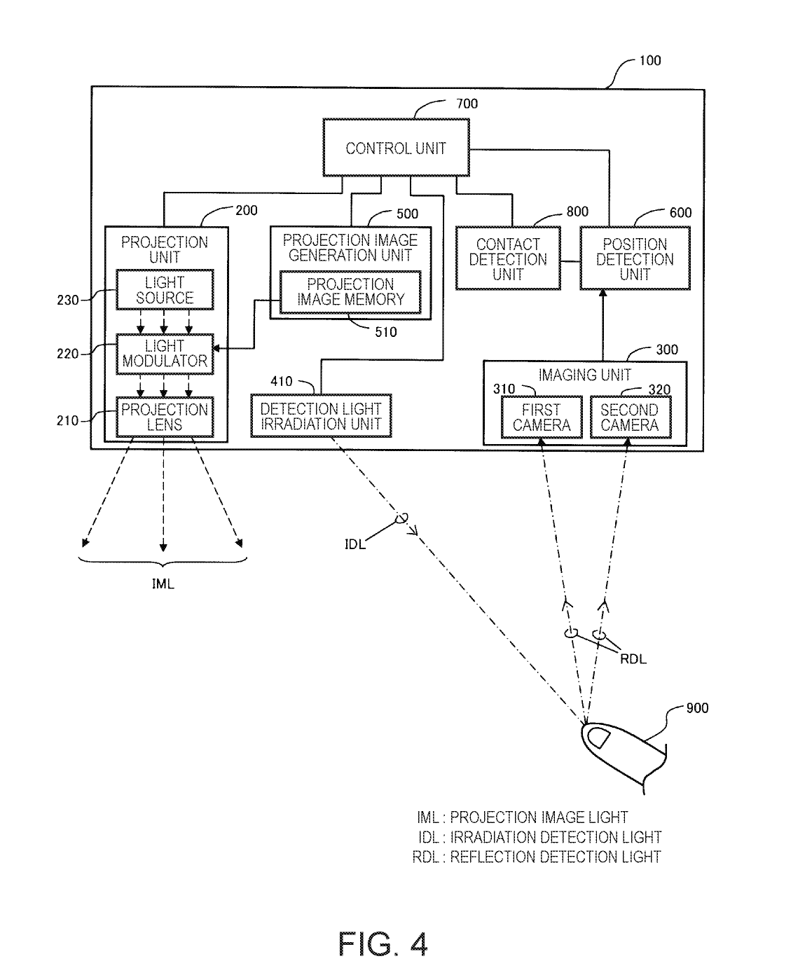

FIG. 4 is a block diagram illustrating an internal configuration of the projector 100. The projector 100 includes a projection unit 200, an imaging unit 300, a projection image generation unit 500, a position detection unit 600, a control unit 700, and a contact detection unit 800.

The projection image generation unit 500 includes a projection image memory 510 storing projection image data, and has a function of generating a projection image projected by the projection unit 200. The projection image generation unit 500 further preferably functions as a keystone correction unit which corrects trapezoidal distortion of the projected screen.

The projection unit 200 has a function of projecting the projection image generated by the projection image generation unit 500. The projection unit 200 includes a projection lens 210, a light modulator 220, and a light source 230. The light modulator 220 modulates light from the light source 230 on the basis of projection image data provided from the projection image memory 510, so as to generate projection image light IML. The projection image light IML is typically color image light including visible light of three colors such as RGB, and is projected by the projection lens 210. As the light source 230, not only light source lamps such as an ultra-high pressure mercury lamp but also various light sources such as a light emitting diode or a laser diode may be employed. As the light modulator 220, a transmissive or reflective liquid crystal panel or a digital mirror device may be employed, and a plurality of light modulators 220 may be provided for respective color light beams.

The imaging unit 300 includes a first camera 310 and a second camera 320. The first camera 310 and the second camera 320 have a function of receiving light in a wavelength region including a wavelength of detected light, and performing imaging. Imaging in the first camera 310 and the second camera 320 is performed on both of a period in which irradiation detection light IDL is applied from a detection light irradiation unit 410 and a period in which the irradiation detection light IDL is not applied from the detection light irradiation unit 410.

The first camera 310 and the second camera 320 preferably have a function of performing imaging by using light including near infrared light and further a function of performing imaging by using light including visible light. In this way, the cameras can capture an image of a projected image, and the projection image generation unit 500 performs keystone correction by using the image. A method of performing keystone correction using one or more cameras is well known, and thus a description thereof will be omitted here.

The position detection unit 600 has a function of analyzing images captured by the first camera 310 and the second camera 320, and calculating three-dimensional position coordinates of a front end of an indicator 900 by using triangulation.

The contact detection unit 800 detects contact of the indicator 900 with the screen member 30 on the basis of the three-dimensional position coordinates detected by the position detection unit 600.

The control unit 700 includes a CPU and a storage medium, and controls the respective units of the projector 100.

The control unit 700 determines the content of an instruction given by an indicator 900 on a dialogue screen D (which will be described later) on the basis of a three-dimensional position of the indicator 900 detected by the position detection unit 600, and contact of the indicator 900 detected by the contact detection unit 800. The indicator 900 is, for example, the finger of the patient K1 or an assistant. The control unit 700 instructs the projection image generation unit 500 to create or change a projection image according to the content of the instruction.

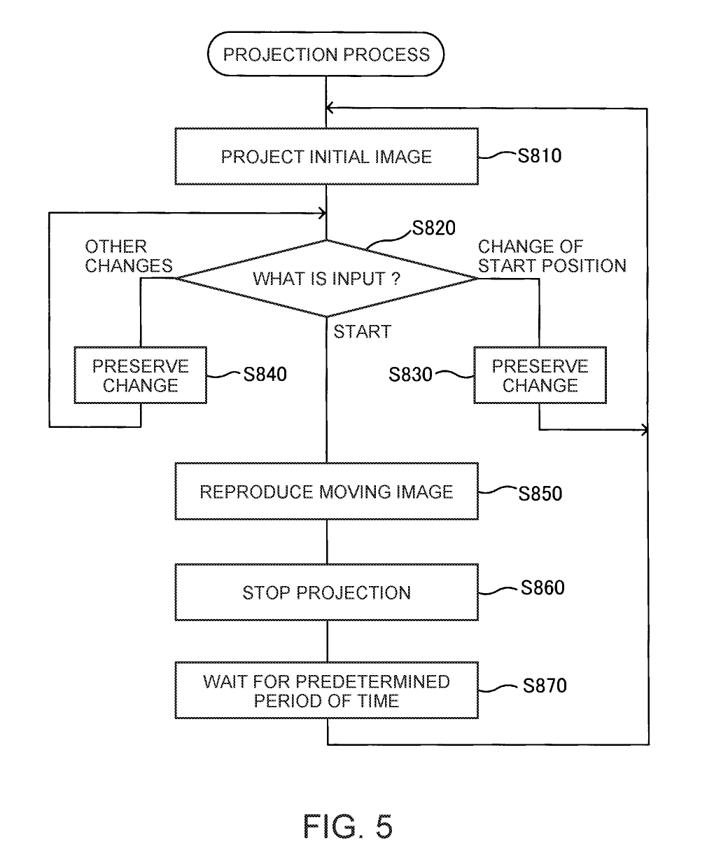

FIG. 5 is a flowchart illustrating a projection process. The projection process is performed by the CPU of the control unit 700 executing a program stored in the storage medium of the control unit 700. The control unit 700 starts the projection process when power is supplied to the projector 100. First, an initial image SG is projected (step S810).

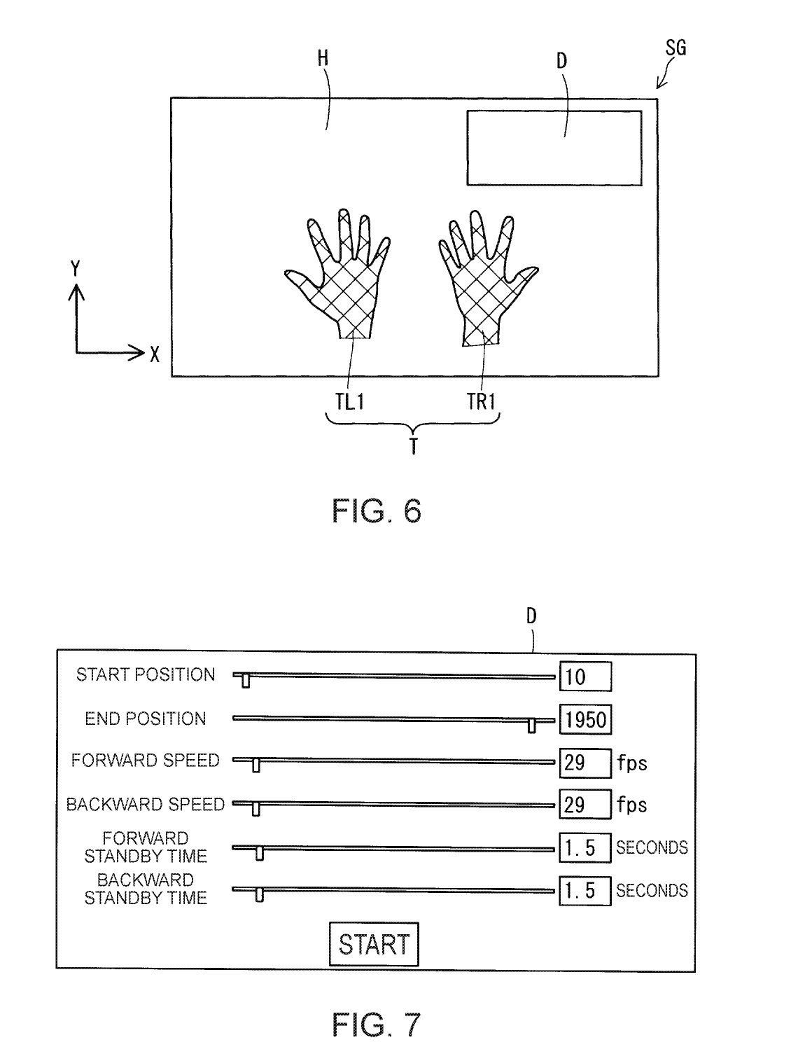

FIG. 6 illustrates the initial image SG. As illustrated in FIG. 6, the initial image SG includes a background H, the dialogue screen D, and images T in a first state. The background H is a blank and white image region. The images T are images of both hands, and include a left hand image TL1 and a right hand image TR1. Colors of the images T are determined in accordance with a skin color of the patient K1.

The first state is a state in which the hands are opened. In contrast, a second state is a state in which the hands are closed. Both of the first and second states are states in which the backs of the hands face downward in the Z direction, and the palms face upward in the Z direction. Therefore, the images T in the initial image SG include images of the palms.

FIG. 7 is an enlarged view of the dialogue screen D. The dialogue screen D is a screen for setting and inputting reproduction conditions of the images T. Inputting to the dialogue screen D is performed by the patient K1 or an assistant.

As illustrated in FIG. 7, the dialogue screen D includes a start position, an end position, a forward speed, a backward speed, forward standby time, and backward standby time as setting items. Each of these setting items is provided with a slide bar and display of a set value. The patient K1 or the assistant traces the screen member 30 with the finger so as to move the slide bar rightward and leftward, and can thus change a set value of each setting item.

The start position is an item for setting an image used in the first state. As a numerical value is reduced, this corresponds to a state in which the hand is further opened. The end position is an item for setting an image used in the second state. As a numerical value is increased, this corresponds to a state in which the hand is further closed.

The forward speed is an item for setting a speed at which an image changes in forward transition. The forward transition indicates transition from the first state to the second state. Conversely, transition from the second state to the first state is referred to as backward transition. A speed at which an image changes in the backward transition is the backward speed illustrated in FIG. 7.

A period of time in which movement of the images T is stopped between an operation of the backward transition and an operation of the forward transition is provided. Such stoppage of movement of the images T is referred to as forward standby, and a standby time is referred to as a forward standby time.

Similarly, a period of time in which movement of the images T is stopped between an operation of the forward transition and an operation of the backward transition is provided. Such stoppage of movement of the images T is referred to as backward standby, and a standby time is referred to as a backward standby time. Therefore, movement of the images T is performed in an order of the forward transition, the backward standby, the backward transition, and the forward standby. The movement of the images T is repeatedly performed from the forward transition after the forward standby.

“Start” disposed under the setting items is display for starting an operation of the images T.

After step S810, an instruction which is input via the dialogue screen D is determined (step S820). In a case where a start position is changed (change of start position in step S820), the changed start position is stored (step S830), and the flow returns to step S810. The changed start position is reflected in second step S810.

In a case where set values other than the start position are changed (other changes in step S820), the control unit 700 stores changed set values therein (step S840), and returns to step S820. In a case where a starting instruction is input (start in step S820), moving images in which the images T change are reproduced (step S850).

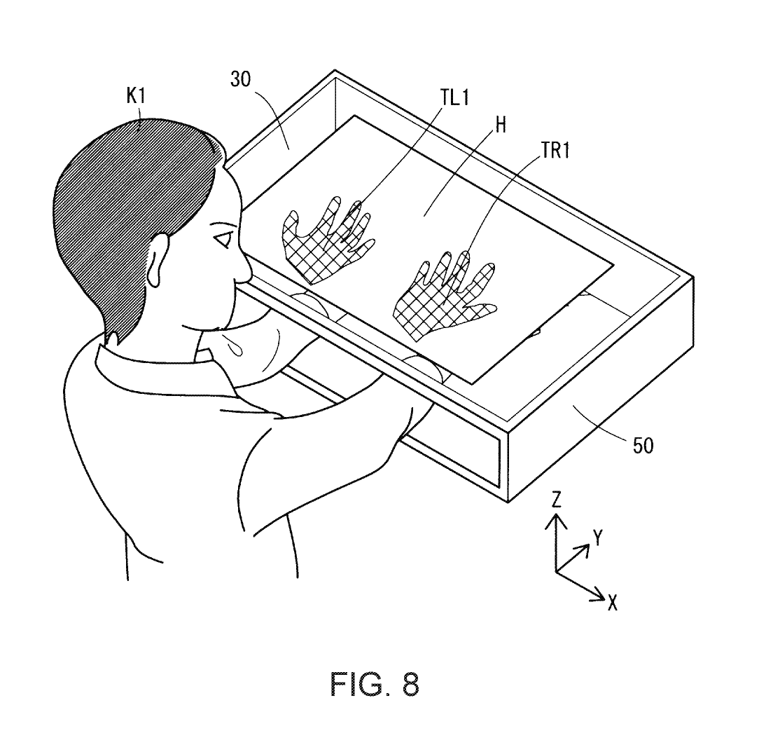

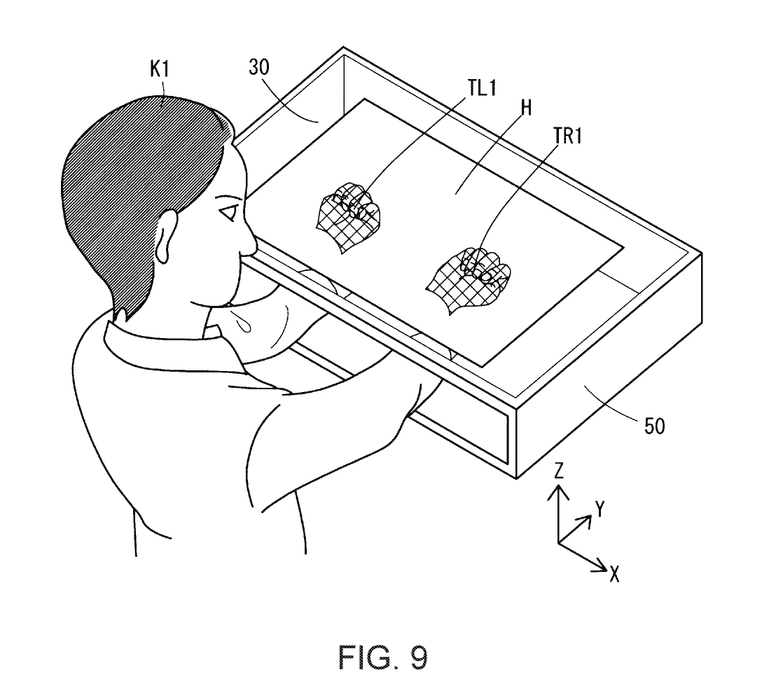

FIG. 8 is a diagram illustrating the first state during reproduction of the moving images. FIG. 9 is a diagram illustrating the second state during reproduction of the moving images. During reproduction of moving images, the dialogue screen D is not projected unlike the initial image SG.

As illustrated in FIGS. 8 and 9, the patient K1 cannot visually recognize both hands thereof during reproduction of the moving images. This is because the white background H is projected onto the screen member 30 which functions as a beam splitter. In other words, light projected as the background H is reflected, and thus the left hand L1 and the right hand R1 located on an opposite side to the screen member 30 cannot be visually recognized.

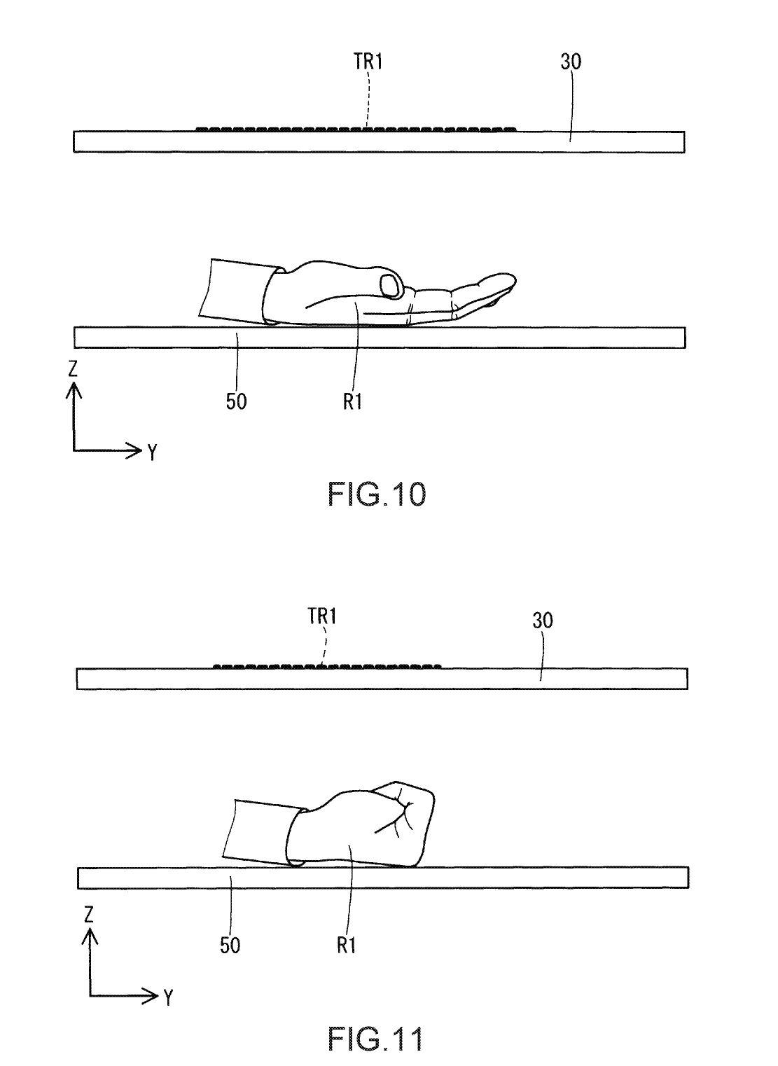

FIG. 10 is a sectional view illustrating the first state during reproduction of moving images. FIG. 11 is a sectional view illustrating the second state during reproduction of moving images. The patient K1 disposes the right hand R1 thereof directly under the right hand image TR1 as illustrated in FIGS. 10 and 11. The patient K1 disposes the left hand L1 thereof directly under the left hand image TL1 (not illustrated). The patient K1 opens or closes both hands in accordance with movement of the images T. This action is referred to as simultaneous emulation in the present embodiment.

As mentioned above, in step S850, the images T are displayed in order to perform simultaneous emulation, and both hands of the patient K1 are shielded from the visual field of the patient K1 by projecting the background H.

The moving images are reproduced for a predetermined period of time, and then projection is stopped (step S860), and standby occurs for a predetermined period of time (step S870). Then, the flow returns to step S810, and the initial image SG is projected. The predetermined period of time as the reproduction time of moving images may be time of the same length as the predetermined period of time as standby time, and may be time of a length which is different therefrom.

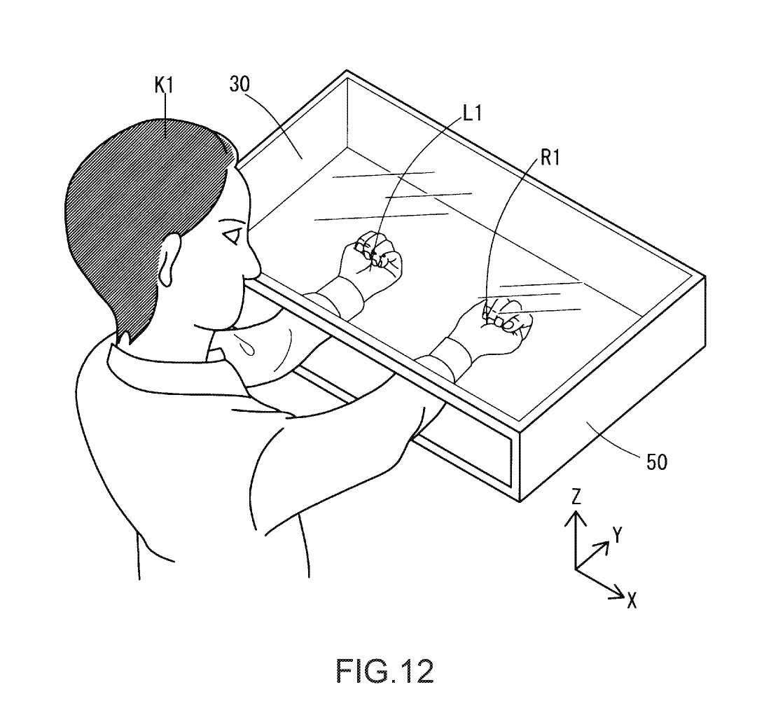

FIG. 12 illustrates a state in which projection is stopped, and both hands of the patient are in the second state.

A state in which projection is stopped, and both hands of the patient are in the first state is illustrated in FIG. 3. If projection is stopped, the patient K1 can visually recognize both hands thereof. Step S860 corresponds to a transition operation for stopping the shielding which is performed in step S850.

The patient K1 visually recognizes both hands thereof, and emulates the movement of the images T by memory of performing the simultaneous emulation so as to open and close both hands. This action is referred to as immediately subsequent emulation.

According to the present embodiment, at least following effects can be achieved.

(A) A patient is made to alternately perform simultaneous emulation and immediately subsequent emulation, and a rehabilitation effect is improved. In other words, an illusion due to the simultaneous emulation and recognition of a action state of the user's hands due to the immediately subsequent emulation are repeated, and thus memory of rehabilitation is fixed so that there is a high probability that a rehabilitation effect may last.

(B) The above (A) can be realized only by projecting the images T or stopping projection of the image T. Therefore, the medical apparatus 20 can be implemented with a simple configuration.

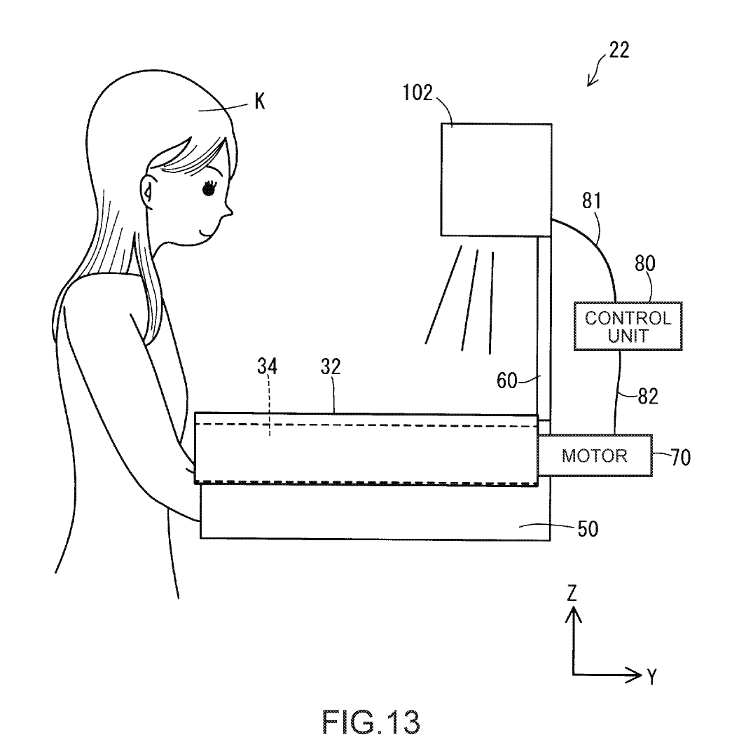

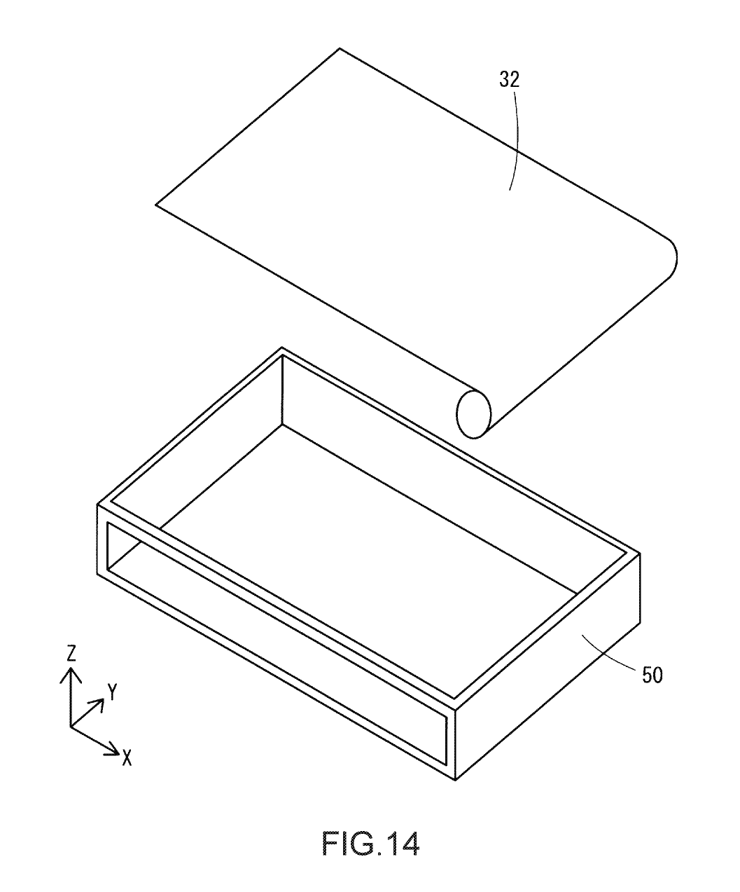

FIG. 13 is a side view of a medical apparatus 22 in Embodiment 2. The medical apparatus 22 includes a screen member 32, a core member 34, a box 50, a column 60, a motor 70, a control unit 80, a wiring 81, a wiring 82, and a projector 102. The box 50 and the column 60 are the same as those in Embodiment 1.

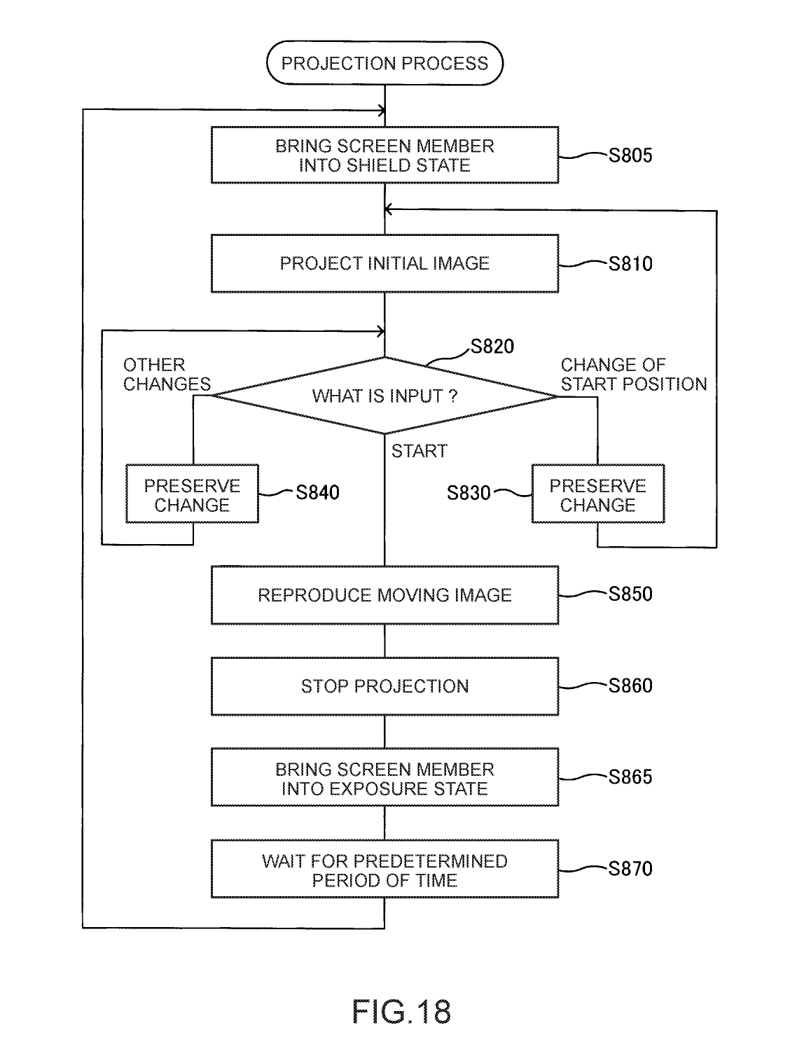

The control unit 80 is a notebook PC which performs communication with the motor 70 via the wiring 82, and performs communication with the projector 102 via the wiring 81. A projection process (which will be described later with reference to FIG. 18) in Embodiment 2 is performed through a cooperative operation with the motor 70 and the projector 102. The control unit 80 performs communication with the motor 70 and the projector 102 for this cooperative operation.

The motor 70 is a power generation device which is connected to the core member 34 so as to rotate the core member 34. If the core member 34 is rotated, the screen member 32 is pushed out or drawn (refer to FIG. 15).

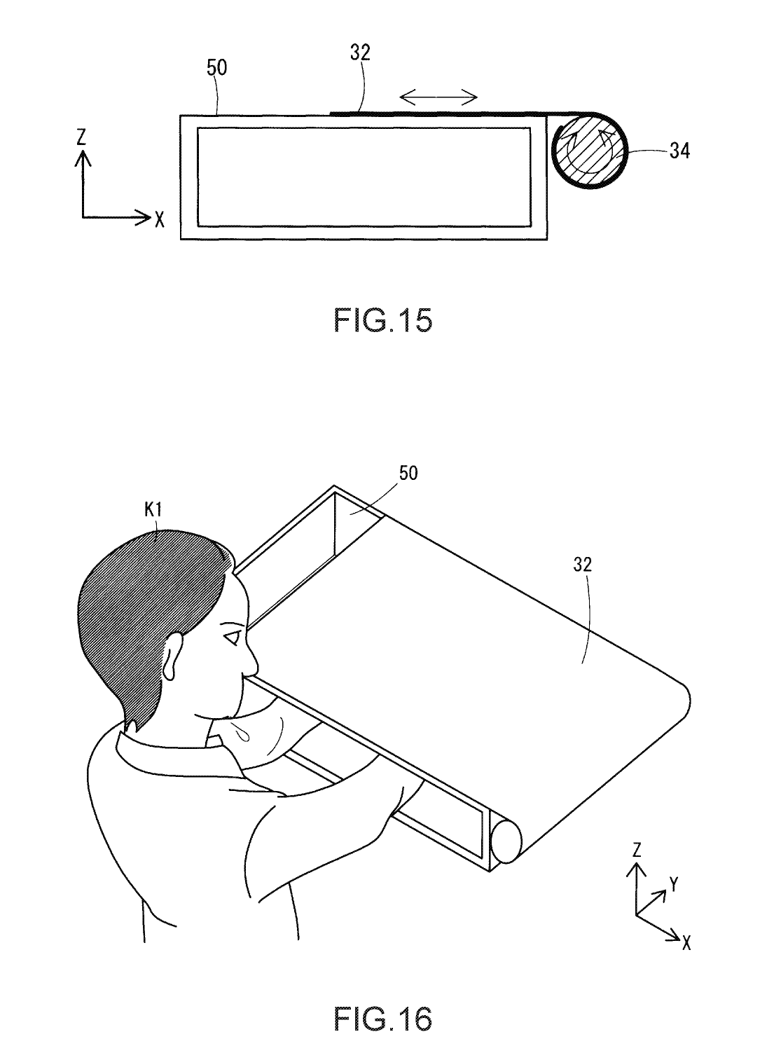

FIG. 14 is an exploded perspective view of the screen member 32 and the box 50. The screen member 32 is made of material (for example, a mat-based or bead-based material) which is generally used to display a projection image. A surface of the screen member 32 is white.

FIG. 15 illustrates a state in which the screen member 32 is pushed out or drawn. The core member 34 is a cylindrical member. One end of the screen member 32 is adhered to the core member 34. If the core member 34 is rotated by torque of the motor 70, a position of the other end of the screen member 32 is moved in the X direction. For example, if the core member 34 is rotated in a clockwise direction in FIG. 15, a position of the other end of the screen member 32 is moved in a positive direction (a rightward direction in FIG. 15) of the X direction. As a result, an area of a portion of the screen member 32 placed on the box 50 is reduced, and, accordingly, the inside of the box 50 is easily visually recognized from the top.

In contrast, if the core member 34 is rotated in a counterclockwise direction in FIG. 15, a position of the other end of the screen member 32 is moved in a negative direction (a leftward direction in FIG. 15) of the X direction. As a result, an area of a portion of the screen member 32 placed on the box 50 is increased, and, accordingly, the inside of the box 50 is hardly visually recognized from the top.

The torque of the motor is controlled by an instruction from the control unit 80. The control unit 80 controls the motor 70 in the above-described manner, and thus functions as a device determining how to dispose the screen member 32.

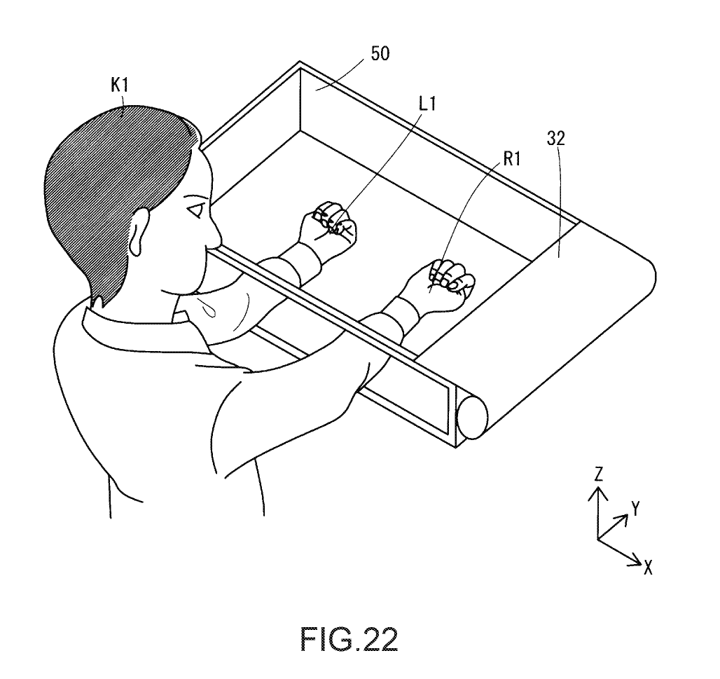

FIG. 16 illustrates a state in which the patient K1 puts both hands into the box 50. As illustrated in FIG. 16, if the screen member 32 is pushed out so as to cover a most part of the box 50, the patient K1 cannot visually recognize both hands put into the box 50. In other words, both hands of the patient K1 are shielded from the visual field of the patient K1. Hereinafter, a state in which the screen member 32 is pushed out in the above-described way will be referred to as a shield state. In contrast, a state in which the screen member 32 is drawn so that the patient K1 can visually recognize both hands thereof put into the box 50 will be referred to as an exposure state (refer to FIGS. 21 and 22).

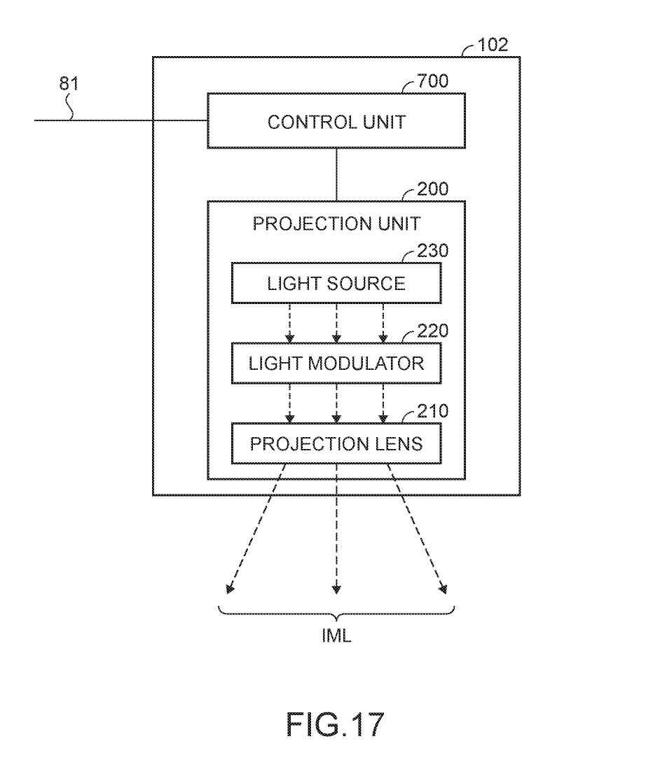

FIG. 17 is a block diagram illustrating an internal configuration of the projector 102. The projector 102 includes a projection unit 200 and a control unit 700. The projection unit 200 is the same as that of the projector 100 of Embodiment 1.

The projector 102 does not include the imaging unit 300, the position detection unit 600, the projection image generation unit 500, and the contact detection unit 800 unlike the projector 100 of Embodiment 1. This is because a function of the projector 102 is more restricted than a function of the projector 100 of Embodiment 1. Specifically, the projector 102 does not have an interactive function, and does not store image data either. The projector 102 receives or acquires an instruction from a user or image data from the control unit 80 via the wiring 81.

FIG. 18 is a flowchart illustrating a projection process of Embodiment 2. The projection process is performed by a CPU of the control unit 80 executing a program stored in a storage medium of the control unit 80. The projection process is started when an instruction for starting the projection process is input to an input I/F provided in the control unit 80.

First, the screen member 32 is brought into a shield state (step S805). Specifically, an instruction for setting a rotation direction position to a predetermined position is transmitted to the motor 70 via the wiring 82. The predetermined position is a rotation direction position at which the screen member 32 is brought into a shield state. Next, an initial image SG2 is projected (step S810). Specifically, image data of the initial image SG2 is transmitted to the projector 102 so as to be projected.

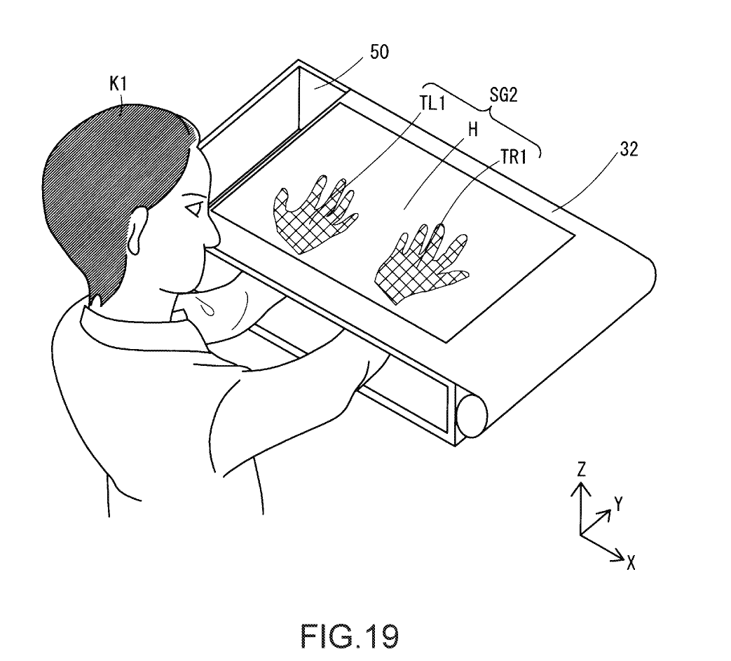

FIG. 19 illustrates a state in which the initial image SG2 is projected. The initial image SG2 includes a left hand image TL1, a right hand image TR1, and a background H in the same manner as in Embodiment 1. On the other hand, the initial image SG2 does not include a dialogue screen unlike the initial image SG of Embodiment 1.

After step S810, the instruction which is input via the input I/F is determined (step S820). In a case where a start position is changed (change of start position in step S820), the control unit 700 stores the changed start position therein (step S830), and returns to step S810. The changed start position is reflected in second step S810.

In a case where set values other than the start position are changed (other changes in step S820), the changed set values are stored (step S840), and the flow returns to step S820. In a case where a starting instruction is input (start in step S820), moving images in which the images T change are reproduced (step S850). Specifically, moving image data in which the images T change is transmitted to the projector 102 so as to be projected.

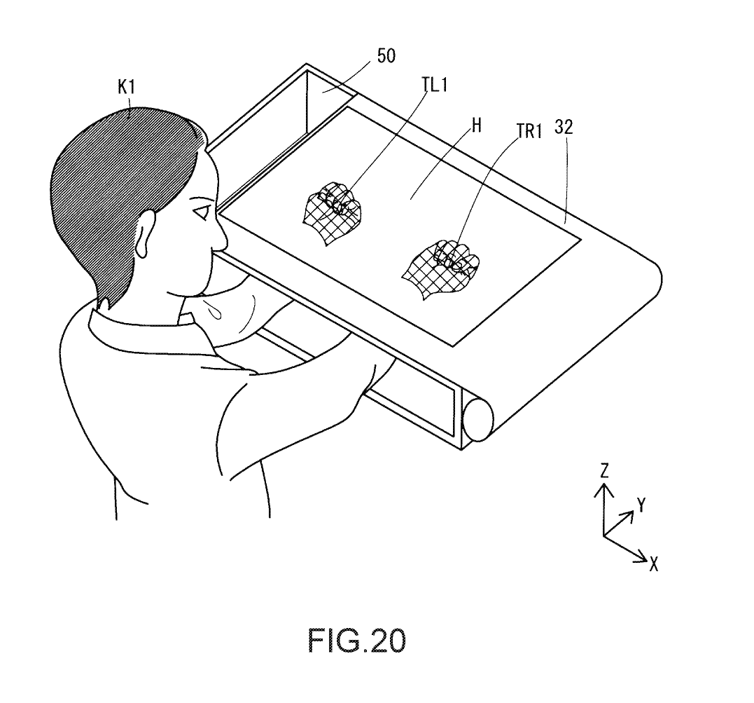

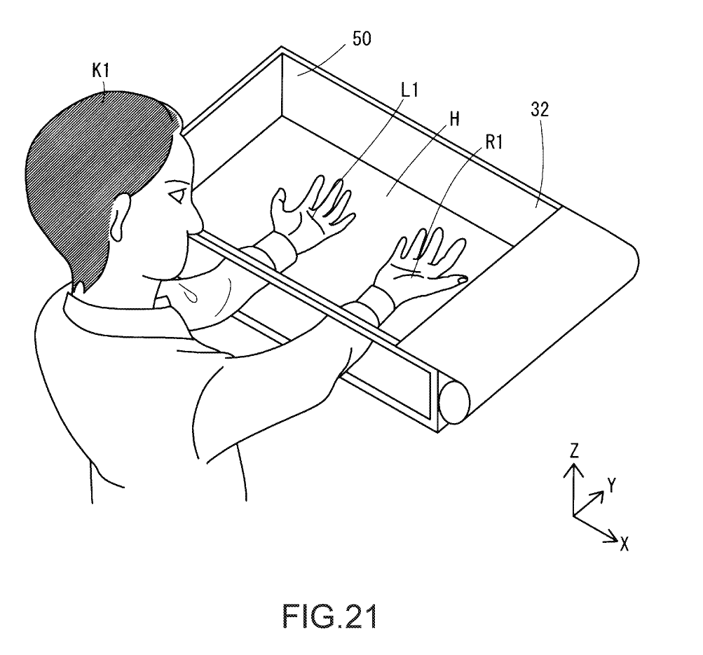

FIG. 20 illustrates the second state during reproduction of moving images. The first state during reproduction of moving images is the same as in the initial image SG2 (FIG. 19). However, in a case where the start position is changed, the left hand image TL1 and the right hand image TR1 differ in the first state and the initial image SG2.

The reproduction of the moving images (step 5850) is continuously performed for a predetermined period of time. During that time, the patient K1 performs simultaneous emulation. If the predetermined period of time elapses, the projection is stopped (step S860). Next, the screen member 32 is brought into an exposure state (step S865).

FIGS. 21 and 22 illustrate an exposure state. As described above, in the exposure state, the patient K1 can visually recognize both hands thereof put into the box 50. In other words, step S865 corresponds to a transition operation for stopping the shielding which is performed in step S805.

The patient K1 performs immediately subsequent emulation in the exposure state. If a predetermined period of time elapses from the exposure state, the flow returns to step S805 so that transition to a shield state occurs.

According to the present embodiment, at least following effects can be achieved.

(a) The patient K1 can alternately perform simultaneous emulation and immediately subsequent emulation in the same manner as in Embodiment 1.

(b) The above (a) can be realized only by pushing out or drawing the screen member 32. Therefore, the medical apparatus 22 can be implemented with a simple configuration.

The invention is not limited to the embodiments, Examples, and modification examples of the present specification, and may be implemented in various configurations within the scope without departing from the spirit thereof. For example, the technical features in the embodiments, Examples, and modification examples corresponding to the technical features disclosed in Summary of the Invention may be replaced or combined with each other as appropriate in order to solve some or all of the above-described problems or in order to achieve some or all of the above-described effects. The technical features may be omitted as appropriate as long as the technical features are not described as being essential. This is as follows, for example.

There may be various methods in which both hands of a patient are not visually recognized during simultaneous emulation, and both hands of the patient are visually recognized during immediately subsequent emulation. For example, a see-through display may be used as a configuration of combining a screen member with a display device. In the see-through display, an opposite side may be viewed therethrough, or the opposite side may not be viewed by developing a color of a background. As the screen member, a half mirror, a light controllable glass, a liquid crystal panel, and the like may be used. The half mirror is one kind of beam splitter.

The see-through display or the like may be used in combination with projection. For example, background display for shielding may be realized by developing a color in the see-through display, and moving images may be displayed through projection of moving images.

The beam splitter or the light controllable glass having intermediate transparency may be used so that a patient's hands are slightly viewed therethrough during simultaneous emulation.

In Embodiment 2, a transparent plate may be disposed between the screen member and the box so that an operation of pushing out or drawing the screen member is stably performed.

The setting items using the dialogue screen may be changed. For example, a size of the hand, a color of the hand, a position of the hand, and an angle of the hand may be added. The position of the hand is a two-dimensional position, that is, a position in the X-Y direction. The angle of the hand is a position in a rotation direction when the hand is rotated with respect to a longitudinal direction of the forearm. If an angle of the hand is changed, for example, the palm or the back of the hand faces upward in the Z direction.

In a case where a therapy target part of a patient is visually recognized through movement of the screen member, projection may be continuously performed. Even if projection is continuously performed, a patient cannot clearly visually recognize projected images if the screen member is in an exposure state, and can thus perform immediately subsequent emulation.

A therapy target part may not be the hand. For example, the medical apparatus may be used for therapy performed by imagining that an elbow joint, a shoulder joint, a hip joint, or an ankle moves. A patient's both hands are exemplified as therapy target parts, but one hand may be a therapy target part.

The medical apparatus may be used for therapy of phantom limb pain. For example, in a case of performing therapy of phantom limb pain of a lost left hand, the medical apparatus may be used for a therapy method in which a patient puts the normal right hand into the box, and imagines that the left hand is opened or closed while opening or closing the right hand in the same manner as in the above-described embodiments.

The entire disclosure of Japanese Patent Application No. 2015-197264 filed Oct. 5, 2015 is expressly incorporated by reference herein.

What is claimed is:

1. A medical apparatus comprising:
a screen member on which a moving image in which a therapy target part repeatedly moves is displayed; and
a control unit that shields the therapy target part from the visual field of a patient by using the screen member in a case where the patient is caused to perform a first emulating action, and that performs a transition operation for stopping the shielding in a case where the patient is caused to perform a second emulating action.

2. The medical apparatus according to claim 1,
wherein the screen member allows an opposite side to be viewed therethrough in a case where an image including the moving image is not displayed, and
wherein the control unit realizes the shielding by displaying the image on the screen member, and stops displaying of the image as the transition operation.

3. The medical apparatus according to claim 2, further comprising:
a projection device that performs projection onto the screen member,
wherein the screen member is formed of a beam splitter, and
wherein the control unit displays the moving image by causing the projection device to project the moving image onto the screen member.

4. The medical apparatus according to claim 1, further comprising:
a power generation device that moves the screen member,
wherein the control unit causes the power generation device to move the screen member as the transition operation.

5. A program executed in a display device which displays a moving image in which a therapy target part repeatedly moves on a screen member, the screen member allowing an opposite side to be viewed therethrough in a case where the moving image is not displayed, the program causing the display device to:
display an image including the moving image so that the therapy target part is shielded from the visual field of a patient in a case where the patient is caused to perform a first emulating action; and
stop displaying of the image in a case where the patient is caused to perform a second emulating action.

6. A program for controlling a power generation device moving a screen member which is disposed at a position where a therapy target part is shielded from the visual field of a patient and on which a moving image in which the therapy target part repeatedly moves is displayed in a case where the patient is caused to perform a first emulating action, the program causing the power generation device to:
move the screen member to a position where the shielding is stopped in a case where the patient is caused to perform a second emulating action.
